(19) United States
(12) Patent Application Publication
(10) Pub. No.: US 2017/0300321 A1
(43) Pub. Date: Oct. 19, 2017

(54) COMPUTER CODE QUALITY ASSURANCE THROUGH A SCENE ATTRIBUTE FILTER SYSTEM

(71) Applicant: Blue Sky Studios, Inc., Greenwich, CT (US)

(72) Inventors: Oliver Staeubli, White Plains, NY (US); Mark McGuire, Pound Ridge, NY (US)

(21) Appl. No.: 15/485,598

(22) Filed: Apr. 12, 2017

Related U.S. Application Data
(60) Provisional application No. 62/321,905, filed on Apr. 13, 2016.

(51) Int. Cl. G06F 9/44; G06F 11/36

(52) U.S. Cl. CPC G06F 8/77; G06F 11/3668

(57) ABSTRACT

A method, system, and computer program product for implementing by a filter tool are provided. The filter tool includes abstracting code to create filter stack components and combining the filter stack components into a filter stack. The filter tool also includes publishing the filter stack within an interface of the development environment application and performing a quality assurance test utilizing the filter stack as published.

### CROSS-REFERENCE TO RELATED APPLICATIONS

This patent application claims priority to U.S. Provisional Application No. 62/321,905 filed Apr. 13, 2016, which is incorporated herein by reference in its entirety.

### BACKGROUND

Conventionally, when producing computer animations, animators must perform complex modeling of physical representations of objects/characters, computer-interpretation of those models, and frame-by-frame rendering of movements of those models to mimic live-action. Thereafter, background features are added to and post-processing is performed on those models to render a sharp, detailed computer animation. The animators that perform these modeling, rendering, and processing operations are generally divided into separate production departments. Each department, in turn, manages and executes these operations in a particular order known as a production pipeline. The production pipeline is generally a serial set of actions where each downstream production department generally relies on a work product of an upstream production department.

Conventional computer animation production, in general, requires each animator to individually create and code production objects for use within their separate production departments. Further, the resulting animation objects of conventional computer animation production remain within the context of a corresponding portion of the production pipeline. This can lead to different animators repeating the creation and coding of the animation objects. What are needed are new systems and methods that provide efficiency gains across the production departments and the production pipeline.

### SUMMARY

Embodiments that include a method, system, and computer program product for implementing by a filter tool are provided. The filter tool includes abstracting code to create filter stack components and combining the filter stack components into a filter stack. The filter tool also includes publishing the filter stack within an interface of the development environment application and performing a quality assurance test utilizing the filter stack as published.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a process flow in accordance with an embodiment;

FIG. 2 depicts another process flow in accordance with an embodiment;

FIG. 3 illustrates an interface in accordance with an embodiment;

FIG. 4 illustrates another interface in accordance with an embodiment; and

FIG. 5 depicts a processing system in accordance with an embodiment.

### DETAILED DESCRIPTION

In general, a development environment application provides a generalized interface for creating and coding animated scene data. The generalized interface can include a user interface and/or an application programmable interface constructed from a coding language of the development environment application. By providing the user and/or programmable interfaces through the coding language, the development environment application can be used to create and code animated scene data for proprietary and third party applications that also utilize the coding language. The animated scene data includes animation items/objects/code, which herein are collectively referred to as production objects. A filtering system (or filtering tool/mechanism) can also be utilized within or in conjunction with the development environment application to manage the production objects across separate production departments and a production pipeline.

Embodiments of the filtering system can be configured to extract written code or a library thereof to filter down repetitive production objects. For instance, the filtering system can interface with the development environment application to give end users/developers access to a growing library of production objects. The filtering system can also abstract the filtering (e.g., filter content, aspects, or assets in a scene) of the production objects written within the development environment application so that these production objects can be identified, selected, and applied to any proprietary and third party applications. Thus, the filtering system allows for code reuse across the production pipeline, enables a maximum reusability for the repetitive production objects across different applications, and allows for the ability to easily construct quality assurance processes that look for irregular or incorrect aspects of animated scene data.

In an embodiment, the filtering system arranges production objects in filter stacks to reduce content to find items that match certain conditions. The content that is reduced can include items, such as a list of asset names, objects representing nodes as they are used, and production software.

A filter stack can be a list of one or more components. The components can include generators, filters, and converters. The filter stack can start with the generator. Generators are objects at a top of the filter stack used to generate input data for the filter stack.

A filter is an object that is associated with a condition and when applied to the input data from the generator return all items that match the condition of the filter. The items returned can be a sub-list of the input data. The conditions are represented by the filters themselves. For example, if an animator requires all assets that are actors that have blue hair, the filters then apply the conditions that meet blue hair within the filter stack. This can, in turn, reduce an input list to only actors with blue hair.

Converters are objects that receive a given list of items and transform the contents of that list to a new data type. In an embodiment, convertors can follow a generator, receives asset names, and provide the asset names to a node.

The filters can be arranged in a hierarchy of filter stacks that can have either an AND or an OR operation. In an AND operation, all filters associated with the AND operand need to apply for a production object to be selected by the filter stack. In an OR operation, at least one filter associated with the OR operand needs to apply for a production object to be selected by the filter stack. Generally, the hierarchy of filter stacks orders the filters to enable a broadest filter stroke first so that the filtering system has fewer items to manage as progress is made through the filter stack.

The hierarchy of filter stacks allows complex filtering behavior to be created within the filtering system. Further, the filter stack is then evaluated to produce a result of the quality assurance test. A repair operation can be run on the result. The quality assurance test can correspond to a filter stack, such as by filtering for a negative to test for the need to run a repair action. Filters can be arranged in such a way that left over production objects are the items that failed the quality assurance test, which eliminates the need for additional test case specific code. For example, a quality assurance test can identify all assets (items or production objects) in an animation scene that utilize a latest ‘rig’ based on using a filter that has this condition. That is, the condition of the filter is to pass through all assets in the animation scene that utilize the latest ‘rig.’ In turn, the filter stack can also be arranged to return older versions of the ‘rig’, so that these versions can be eliminated or updated.

The filter system enables filter stack components to be published, along with the filter stack itself, through a source control system and become available in a filter component library. For example, publishing through the filter component library provides access to the filter stack components so that end users/developers across separate production departments and the production pipeline can create new filter stacks without having to re-create filter stack components. In an embodiment, the filter system can utilize a widget (e.g., an element of a graphical user interface that displays information and provides a mechanism for end users/developers to interact with the filter stack components) within the user interface of the development environment application to enable efficient code re-use by enabling a selection of one or more of the published filter stack components. Filters can also be tagged to represent a category of the quality assurance tests that are executed.

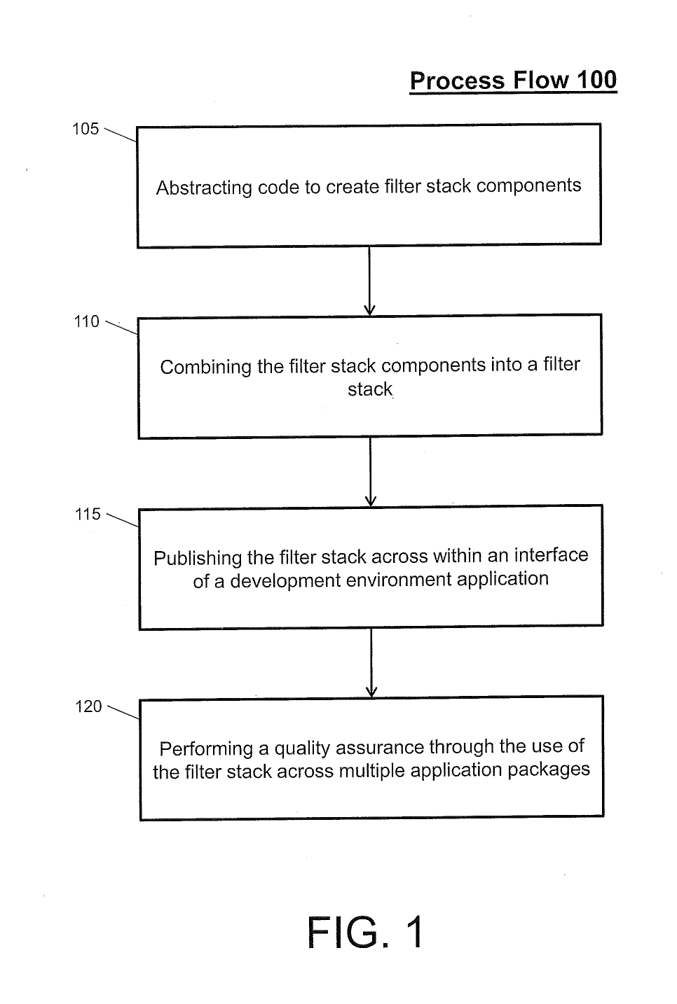

Reference is now made to FIGS. 1-4, which show examples of process flows and interfaces according to embodiments of the filter system.

Beginning with FIG. 1, a process flow 100 is depicted in accordance with an embodiment. Process flow 100 starts at block 105, where a filter system abstracts code to create filter stack components. Abstracting code is a technique for managing complexity of production objects by establishing an interaction level for interfacing with the production objects and suppressing the more complex details below the interaction level. In turn, the animator can work on the interaction level to search and evaluate the production objects, without interfacing with an additional functionality of the production object that would otherwise be too complex to handle. The filter stack components include a generator, at least one filter, and optionally one or more converters.

At block 110, the filter system combines filter stack components into a filter stack. The filter system orders the generator at the top of the filter stack. In an example, the generator can generate an initial list of items, such as a list of asset names, for the at least one filter and the optional converter that follow the generator in the filter stack. The at least one filter is configured to reduce the initial list of items to a list of nodes that match the conditions of the filter stack. The list of nodes can then be passed to the converter. The converter can receive node names corresponding to each node of the list of nodes and provide the node names as a node name string.

At block 115, the filter system publishes the filter stack within an interface of a development environment application. By publishing, the filter stack is available for use and re-use across multiple application packages.

At block 120, the filter system can perform a quality assurance test utilizing the filter stack as published. The quality assurance test is applied across the multiple application packages by invoking the filter stack as published. The quality assurance test and iterations thereof produce quality control production data. The quality control production data can indicate a progress of production objects across separate production departments and a production pipeline.

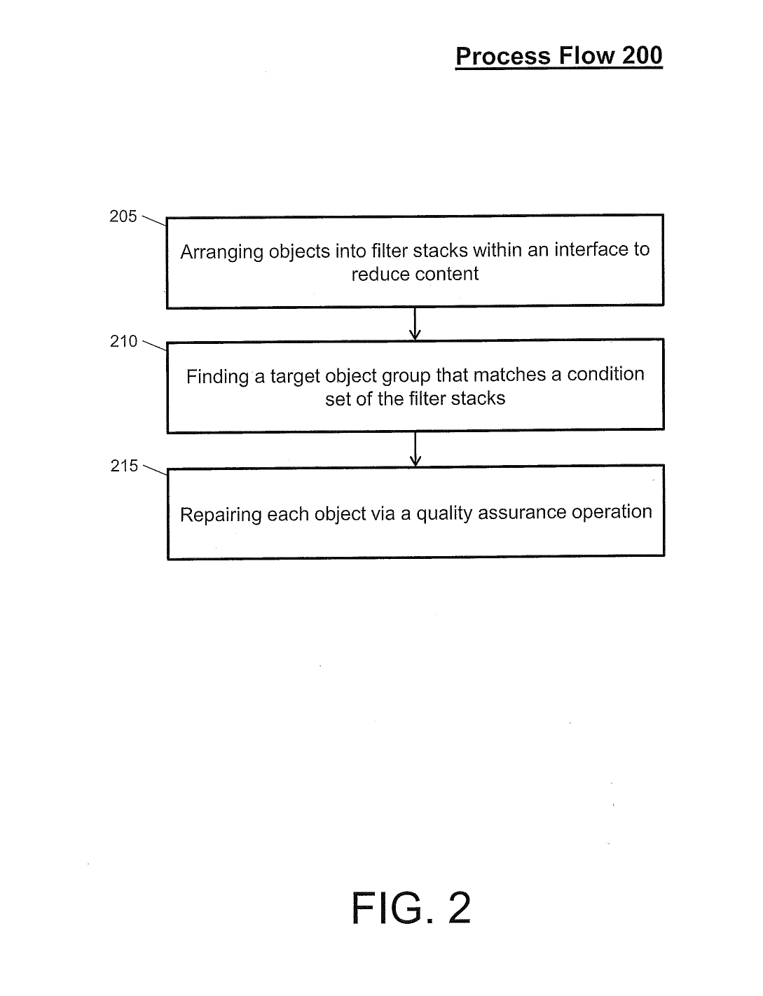

Turning now to FIG. 2, another process flow 200 is depicted in accordance with an embodiment. Process flow 200 starts at block 205, where the filter system arranges objects into filter stacks within an interface to reduce content. That is, the filter system creates an order amongst the objects and places the objects in the filter stack in accordance with that order. The order can group the objects according to a hierarchy. For instance, a filter stack can include a first group and a second group; the first group can include an AND operation of all the filters in the first group; the second group can include an OR operation of all the filters in the second group; and the first group can have a higher rank than the second group so that the first group is executed before the second group by the filter stack.

At block 210, the filter system finds a target object group that matches a condition set within the filter stacks. At block 215, the filter system repairs each object via a quality assurance operation. In an example, once the target object group is extracted, the quality assurance operation is applied to the target object group so that the filter system can identify irregular or incorrect aspects of animated scene data.

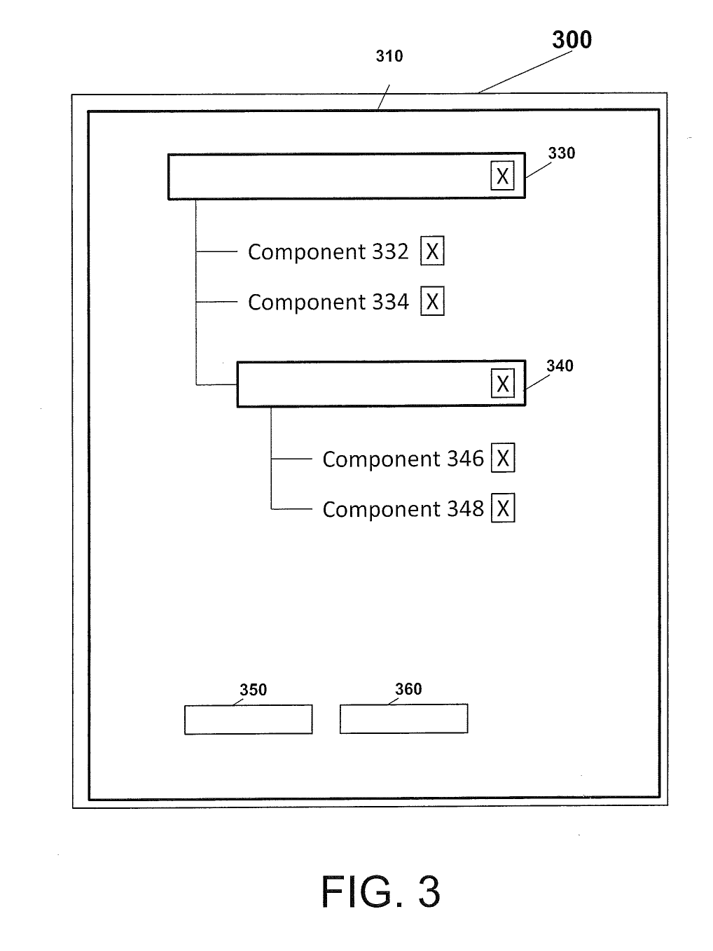

Turning now to FIG. 3, an interface 300 executed by the filter system is depicted in accordance with an embodiment. The interface 300 includes a task filter panel 310 that further includes a filter stack 330 comprising a component 332, a component 334, and a filter sub-stack 340. The filter sub-stack 340 comprises a component 346 and a component 348. The interface 300 includes a button 350 that can be an edit button used to manipulate elements of the task filter panel 310, such as by permitting the addition of new filter stack components and/or activating each cancelation button (e.g., grey box with an internal ‘x’) that allows end users/developers to remove or delete the elements. In addition, the task filter panel 310 includes an apply button 360 that enables end users/developers to apply the filter stack 330 to an animated scene.

In an embodiment, the component 332 is a generator used to generate input data for the filter stack 330. Note that the component 332 is a first item of the filter stack 330. The component 334 is a filter that when applied to the input data from the component 332 returns all items that match the condition. Next, the filter sub-stack 340 is applied to the items that match the condition. The filter sub-stack 340 is an OR group that allows the filter system to select any of the items that match the component 346 or the component 348.

An example of when the apply button is selected by an end user will now be described. The component 332 can be an ‘AllMayallode’ generator that extracts from a set of production objects of an animated scene a list of all Maya nodes as the input data (note that Maya is an editor utilized by end users/developers to create animation workflows, such as rigging). The list of all Maya nodes can then be passed to the component 334 for further manipulation. The component 334 can be a filter associated with the condition ‘AnimatedMayaNode’ that reduces the list of all Maya nodes of the animated scene to a list of all animated Maya nodes. Next, the list of all animated Maya nodes is passed to the filter sub stack 340, which can include an ‘EyeBallSetup1’ as the component 346 and an ‘EyeBallSetup2’ as the component 348. In turn, the list of all animated Maya nodes is further reduced to only animated Maya nodes that match the ‘EyeBallSetup1’ or ‘EyeBallSetup2’. In this way, the output of the filter sub-stack 340, which can be a list, does not include any items that do not match the component 346 or the component 348.

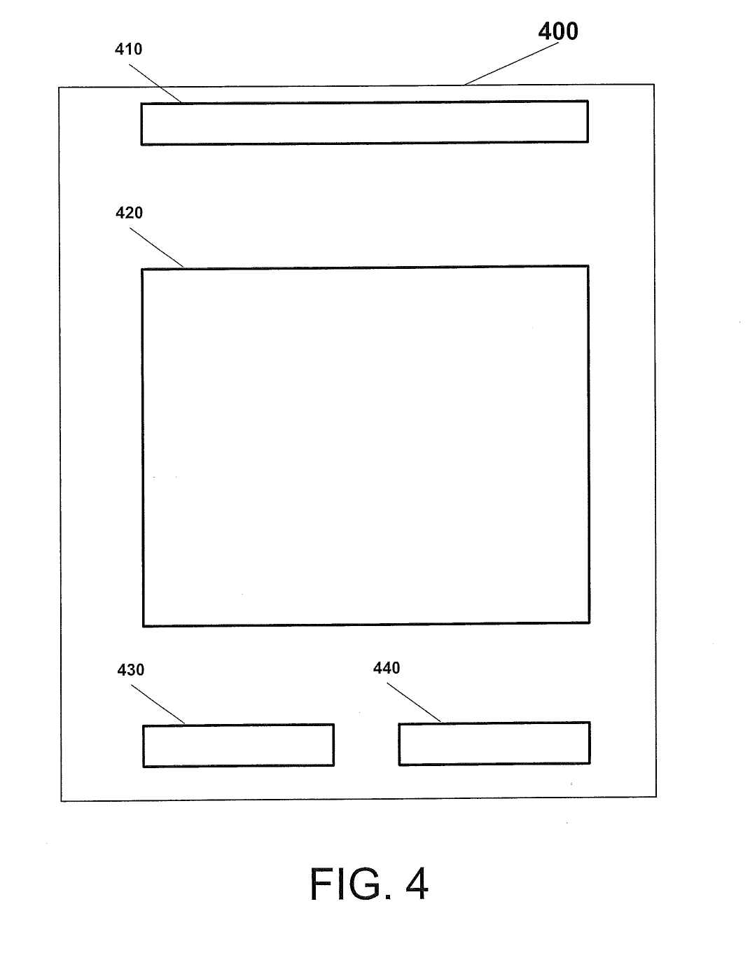

Turning now to FIG. 4, an interface 400 of the filter system is depicted in accordance with an embodiment. The interface 400 is an example of an interface for browsing the library of published filters and selecting a filter to insert into the stack as depicted in FIG. 3. The interface 400 includes a tag field 410 that is configured to receive tags and a component panel 420 that displays a list of filter stack components (e.g., displays the published library). Further, the interface 400 includes an apply button 430 and a close button 440. The apply button 430 triggers the addition of the selected component of 420 into a filter stack depicted in FIG. 3. The close button 440 exits the interface 400.

In view of the above, the technical effects and benefits of embodiments herein include providing a filter system for managing production objects to achieve efficiency gains across separate production departments and a production pipeline. Thus, embodiments of the filter system described herein are necessarily rooted in a processor coupled to a memory to perform proactive operations to overcome problems specifically arising in the realm of animation production (e.g., repeating the creation and coding of the animation objects).

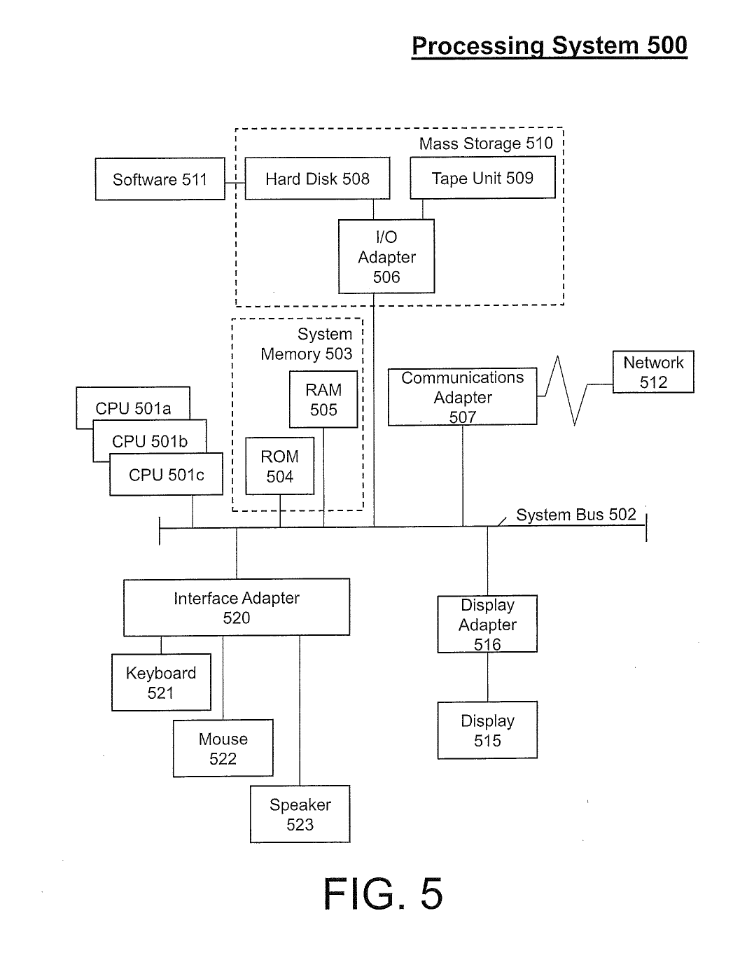

A computer system or an apparatus herein may implement embodiments. For example, FIG. 5 illustrates a processing system 500 as a computer apparatus, according to an embodiment. In this embodiment, the processing system 500 has one or more central processing units (processors) 501a, 501b, 501c, etc. (collectively or generically referred to as processor(s) 501). Therefore, portions or the entirety of the methodologies described herein may be executed as instructions in the processor 501 of the processing system 500. The processors 501, also referred to as processing circuits, are coupled via a system bus 502 to system memory 503 and various other components. The system memory 503 can include read only memory (ROM) 504 and random access memory (RAM) 505. The ROM 504 is coupled to system bus 502 and may include a basic input/output system (BIOS), which controls certain basic operations of the processing system 500. RAM is read-write memory coupled to system bus 502 for use by processors 501. The system memory 503 can be utilized for storage of instructions and information

FIG. 500 further depicts an input/output (I/O) adapter 506 and a communications adapter 507 coupled to the system bus 502. I/O adapter 506 may be a small computer system interface (SCSI) adapter that communicates with a hard disk 508 and/or tape storage drive 509 or any other similar component. I/O adapter 506, hard disk 508, and tape storage drive 509 are collectively referred to herein as mass storage 510. Software 511 for execution on processing system 500 may be stored in mass storage 510. The mass storage 510 is an example of a tangible storage medium readable by the processors 501, where the software 511 is stored as instructions for execution by the processors 501 to perform a method, such as the process flows of FIGS. 1-2. Communications adapter 507 interconnects system bus 502 with an outside network 512 enabling processing system 500 to communicate with other such systems. A display 515 (e.g., a display monitor) can be connected to system bus 502 by display adapter 516, which may include a graphics controller to improve the performance of graphics intensive applications and a video controller. In one embodiment, adapters 506, 507, and 516 may be connected to one or more I/O buses that are connected to system bus 502 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 502 via an interface adapter 520 and the display adapter 516. A keyboard 521, mouse 522, and speaker 523 can be interconnected to system bus 502 via interface adapter 520, which may include, for example, a Super I/O chip integrating multiple device adapters into a single integrated circuit.

Thus, as configured in FIG. 5, processing system 505 includes processing capability in the form of processors 501, and, storage capability including system memory 503 and mass storage 510, input means such as keyboard 521 and mouse 522, and output capability including speaker 523 and display 515. In one embodiment, a portion of system memory 503 and mass storage 510 collectively store an operating system to coordinate the operations of the various components shown in FIG. 5.

Another embodiment may be implemented, in software, for example, as any suitable computer program on a computer system somewhat similar to the processing system 500. For example, a program may be a computer program product causing a computer to execute the example methods described herein.

Another embodiment may be a system incorporating some or all of the above can include a computer apparatus, a means for display in communication with the computer apparatus, and/or a means for storage in communication with the computer apparatus.

The computer apparatus may be any suitable computer apparatus including a server system, multi-processor system, personal computer, networked computing cluster, computing cloud, or any computer apparatus capable of practicing example embodiments.

The means for display may be any suitable display, including a passive, active, or auto-stereoscopic 3D display (e.g., 3D-LCD, 3D-Plasma, 3D-computer monitor, lenticular screened display, parallax barrier screened display) or a conventional display (e.g., computer monitor, LCD, plasma, etc.).

The means for storage (e.g., mass storage 510 and/or system memory 503) may be any suitable storage means disposed to store information related to 3D animation. The storage means may include a single storage element, or a plurality of storage elements. The storage means may be used in combination with any storage available on the computer apparatus, or may be omitted if suitable storage is available on the computer apparatus. The storage means may include backup elements and/or recording elements. The recording elements may be disposed and configured to produce usable copies of any 3D animation produced at the computer apparatus. The usable copies are copies of a 3D animation which are viewable at a suitable apparatus. For example, a suitable apparatus may include a means for reading 3D animation data from a copy (DVD, double-reel film, recording media, etc.). The suitable apparatus may also include means for displaying stereoscopic images/frames read from the 3D animation data. The displaying may include displaying left/right frames in parallel, successively, superimposed, or in any suitable fashion.

According to yet another example embodiment, a computer program product can include a tangible storage medium readable by a computer processor and storing instructions thereon that, when executed by the computer processor, direct the computer processor to perform a method in accordance with some or all of the above. Example may include a computer program product on a computer usable medium with computer program code logic containing instructions according to the FIGS. 1-2 embodied in tangible media as an article of manufacture. Articles of manufacture for computer usable medium may include floppy diskettes, CD-ROMs, hard drives, universal serial bus (USB) flash drives, or any other computer-readable storage medium, wherein, when the computer program code logic is loaded into and executed by a computer, the computer becomes an apparatus for practicing the embodiments described herein. Embodiments include computer program code logic, for example, whether stored in a storage medium, loaded into and/or executed by a computer, or transmitted over some transmission medium, such as over electrical wiring or cabling, through fiber optics, or via electromagnetic radiation, wherein, when the computer program code logic is loaded into and executed by a computer, the computer becomes an apparatus for practicing the embodiments described herein. When implemented on a general-purpose microprocessor, the computer program code logic segments configure the microprocessor to create specific logic circuits.

The computer-readable storage medium may be a built-in medium installed inside a computer main body or removable medium arranged so that it can be separated from the computer main body.

Further, such programs, when recorded on computer-readable storage media, may be readily stored and distributed. The storage medium, as it is read by a computer, may enable the method(s) disclosed herein, in accordance with an embodiment.

Therefore, the methodologies and systems of example embodiments can be implemented in hardware, software, firmware, or a combination thereof. Embodiments may be implemented in software or firmware that is stored in a memory and that is executed by a suitable instruction execution system. These systems may include any or a combination of the following technologies, which are all well known in the art: a discrete logic circuit(s) having logic gates for implementing logic operations upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical operations or steps in the process, and alternate implementations are included within the scope of at least one example embodiment in which operations may be executed out of order from that shown or discussed, including substantially concurrently or in reverse order, depending on the operability involved, as would be understood by those reasonably skilled in the art.

Any program which would implement operations or acts noted in the figures, which comprise an ordered listing of executable instructions for implementing logical operations, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory. In addition, the scope of the embodiments herein includes embodying the operability of the preferred embodiments in logic embodied in hardware or software-configured mediums.

It should be emphasized that the above-described embodiments, particularly, any detailed discussion of particular examples, are merely possible examples of implementations, and are set forth for a clear understanding of the principles of the claims. Many variations and modifications may be made to the above-described embodiment(s) without departing substantially from the spirit and principles of the claims. All such modifications and variations are intended to be included herein within the scope of this disclosure and protected by the following claims.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting of example embodiments.

It should also be noted that in some alternative implementations, the operations/acts noted may occur out of the order noted in the FIGS. For example, two figures shown in succession may in fact be executed substantially concurrently or may sometimes be executed in the reverse order, depending upon the operability/acts involved.

What is claimed is:

1. A method implemented by a filter tool executed by a processor coupled to a memory, the filter tool being associated with a development environment application, comprising:
abstracting, by the filter tool, code to create filter stack components;
combining, by the filter tool, the filter stack components into a filter stack;
publishing, by the filter tool, the filter stack within an interface of the development environment application; and
performing, by the filter tool, a quality assurance test utilizing the filter stack as published.

2. The method of claim 1, wherein the filter stack components comprise a generator and at least one filter.

3. The method of claim 1, wherein a generator is one of the filter stack components and is arranged at a top of the filter stack.

4. The method of claim 1, wherein a generator is one of the filter stack components and receives input data for the filter stack and creates an initial list of items.

5. The method of claim 1, wherein a filter is one of the filter stack components, is associated with a condition, and returns all items that match the condition when the filter is applied to input data from a generator.

6. The method of claim 5, wherein the items that match the condition are a sub-list of the input data.

7. The method of claim 1, wherein the publishing of the filter stack enables re-use of the filter stack across multiple application packages of the development environment application.

8. The method of claim 1, wherein the quality assurance test is applied across multiple application packages of the development environment application by invoking the filter stack.

9. The method of claim 1, wherein the quality assurance test produces quality control production data, and
wherein the quality control production data indicates a progress of the code across separate production departments and a production pipeline.

10. The method of claim 1, wherein the filter stack components are arranged in a hierarchy configured to enable a broadest filter as a first pass and decreasing filters as subsequent passes across input data as progress is made through the filter stack.

11. A computer program product comprising a computer readable storage medium having program instructions for executing a filter tool embodied therewith, the program instructions executable by a processor to cause the processor to perform:
abstracting, by the filter tool, code to create filter stack components;
combining, by the filter tool, the filter stack components into a filter stack;
publishing, by the filter tool, the filter stack within an interface of the development environment application; and
performing, by the filter tool, a quality assurance test utilizing the filter stack as published.

12. The computer program product in accordance with claim 11, wherein the filter stack components comprise a generator and at least one filter.

13. The computer program product in accordance with claim 11, wherein a generator is one of the filter stack components and is arranged at a top of the filter stack.

14. The computer program product in accordance with claim 11, wherein a generator is one of the filter stack components and receives input data for the filter stack and creates an initial list of items.

15. The computer program product in accordance with claim 11, wherein a filter is one of the filter stack components, is associated with a condition, and returns all items that match the condition when the filter is applied to input data from a generator.

16. The computer program product in accordance with claim 15, wherein the items that match the condition are a sub-list of the input data.

17. The computer program product in accordance with claim 11, wherein the publishing of the filter stack enables re-use of the filter stack across multiple application packages of the development environment application.

18. The computer program product in accordance with claim 11, wherein the quality assurance test is applied across multiple application packages of the development environment application by invoking the filter stack.

19. The computer program product in accordance with claim 11, wherein the quality assurance test produces quality control production data, and
wherein the quality control production data indicates a progress of the code across separate production departments and a production pipeline.

20. The computer program product in accordance with claim 11, wherein the filter stack components are arranged in a hierarchy configured to enable a broadest filter as a first pass and decreasing filters as subsequent passes across input data as progress is made through the filter stack.
